(19) United States
(12) Patent Application Publication
(10) Pub. No.: US 2016/0108893 A1
(43) Pub. Date: Apr. 21, 2016

(54) Portable Multiple Source Electrical Power Unit

(71) Applicant: Pete Agtuca, Auburn, WA (US)

(72) Inventor: Pete Agtuca, Auburn, WA (US)

(21) Appl. No.: 14/516,397

(22) Filed: Oct. 16, 2014

(51) Int. Cl. F03D 9/00; F03D 7/02; H02J 3/38; F03D 7/04; H02J 7/35; H02J 7/14; F03D 11/04; F03D 1/00; H02S 10/12

(52) U.S. Cl. CPC F03D 9/007; F03D 1/001; F03D 7/028; F03D 9/002; H02J 3/38; H02S 10/12; H02J 7/355; H02J 7/1415; F03D 11/04; F03D 7/042

(57) ABSTRACT

A portable, non-fossil fuel, multiple source, electrical power unit that includes a lightweight wind generator assembly and an optional solar panel assembly partially disassembled and stored in a rigid, protecting container. The power unit includes a pivoting tower assembly made of a plurality of tower members that are removed and assembled in an end to end manner to form an elongated tower assembly. A nacelle and wind generator are attached to the distal end of the tower assembly. The wind generator is attached to a lightweight hub assembly that uses lightweight sail/airfoil shaped blades. In one embodiment, the container includes four pivoting outrigger legs. In a second embodiment, the container's four side panels fold downward. Concrete blocks may be used to hold the container upright. Mounted on the container is a solar panel assembly with at least one solar panel and a bank of rechargeable batteries. An electronic control assembly is also provided that enables the operator to control the electrical output from the wind and solar panel assemblies.

This utility patent application is based on and claims the filing date benefit of U.S. provisional patent application (application Ser. No. 61/891,785) filed on Oct. 16, 2013.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

The present invention generally relates to portable, self-containing electrical power units, and more particularly to such units that are assembled and shipped in a single compact storage container and can be easily setup in different environments to generate electricity from the sun or wind.

2. Description of the Related Art

When a weather catastrophic event occurs, such as a tornado, a hurricane, or snow storm, or when a geological catastrophic event occurs, such as a flood, an earthquake or a landslide, all electrical power and telecommunications in a large region may be discontinued. Often, the electrical power and telecommunications are discontinued for several weeks or months that can lead or more deaths and injuries than the initial catastrophic event. Most disaster relief personnel understand the importance to reestablish electrical and telecommunications services to the region when possible.

An important concern for many disaster relief personnel is that subsequent catastrophic events may occur in the region before the region has fully recovered from the first catastrophic event. In some regions large damaging hurricanes may repeatedly follow each other during a hurricane season. In earthquake prone regions, strong secondary tremors or aftershocks will often follow a large earthquake.

When portable electrical generators and emergency equipment is brought into a damaged region, steps must be taken to protect the generators and emergency equipment from subsequent catastrophic events. Often this requires removing the generators or equipment from the damaged region or moving it to a nearby protected shelter.

Today, there are two ‘off grid’, electrical power generating systems available today that do not consume fossil fuels—wind generator systems and solar panel systems. The wind profile, the sunlight profile, and the site condition in an area in a region where portable electrical power is most needed, may be more favorable to one generating system than the other. Sometimes, the wind profile and sunlight profile in a specific location may change from day to day or change within a 24 hour period. If one type of electrical generating system is setup in a location, the wind or sunlight conditions in the location may change reducing the electricity production. If the electrical generator source can be easily converted to produce electricity from the new wind or sunlight condition, optimal energy production may be resumed.

In storm or catastrophic damaged regions, roads, homes and businesses are often destroyed. Therefore, it is desirable that portable electrical power units used in the region be brought into the region disassembled and transported in compact storage containers that can be easily transported in the bed of a truck or via helicopter. When a desired location is found, the container should be easily to unload and the generator should be easy to in a few hours. Ideally, the container should contain all of the hardware and electrical components needed to generate electricity.

One drawback with wind generators is that the hub and rotor assemblies must be installed on high towers so the hub and rotor assemblies are positioned in a ‘clean’, non-turbulent wind stream. Typically, the hub and rotor assemblies are heavy structures and towers must be made of strong material to withstand torque exerted by the wind. With permanent wind generators, the lower ends of the towers are embedded in large concrete footings. With portable wind generators construction setup on quickly and temporarily, large concrete footings are not feasible.

What is needed is a portable, non-fossil fuel dependent, self-containing, multiple source, electrical power unit that can be quickly and easily setup and operation in a few hours, and if needed, easily disassembled and stored in a protected configuration or removed from the region altogether. What is needed is a portable electrical power unit that includes a wind generator and positions the hub and rotor assembly sufficiently high into the wind and is reasonable stable in mild to moderate winds.

### SUMMARY OF THE INVENTION

At the heart of the invention is the discovery that in regions where a catastrophic event has occurred, a portable electrical power generating unit is needed that produces electricity from the wind. If desired, the electrical power generating unit may include solar panels enabling the generating unit to produce electricity from the sun. Also at the heart of the invention is the discovery that the wind and solar generating assemblies may be shipped in a single compact container that may be used as protective shelter and as a base to support the wind generator's tower and as the support substructure for the solar panels.

In summary, the invention is a portable electrical power unit that includes a lightweight wind generator mounted on the upper end of tower assembly. The power unit may also include an optional solar panel assembly. Both the wind generator assembly and the solar panel assembly are disassembled and stored in a rigid, protective container that also acts as a support structure for holding the wind generator components and the solar panel components when producing electricity.

The tower assembly made up of a plurality of short tower members disassembled and stored inside the removed from the container. When needed, the tower members are removed from the container and assembled in an end-to-end manner to form an elongated tower. Mounted inside the container is a pivoting pedestal that attaches to the proximal end of the lower tower section. The pivoting pedestal allows the tower assembly to be horizontally disposed so the short tower members may be easily assembled or dissembled on the ground, thereby eliminating the need for a crane. The tower assembly is then rotated by a hydraulic arm to a vertically aligned the tower assembly over the container's center of gravity.

In a first embodiment, the container includes two side walls, a rear wall, a floor panel and a roof panel. Formed on the roof panel is an optional slot that receives the tower assembly when disposed in a vertical alignment. Also located inside the container are four outrigger legs selectively removed from the container that laterally extended and connected to the opposite sides or corners of the container. When the legs are extended, a legs and the bottom panel form a wide base configured that securely holds the tower assembly in a vertical position.

In a second embodiment, the container includes four side walls, a floor panel and a roof panel. The lower edges of the four side wall are connected to the floor panels via hinges that enable the four side walls to fold outward to form a wide support base. The roof panel is attached to a pivoting center post located inside the container upon. The tower assembly is mounted on the roof panel.

The wind generator assembly which is also completely stored inside the container, includes a rotating nacelle, a low RPM, high torque generator attached to a relatively lightweight hub assembly. The hub assembly includes three to eight lightweight sail/airfoil-shaped blades that begin rotated in lower wind speeds and are more responsive to changes in the wind speed.

Also mounted inside the container is the optional solar panel assembly and a bank of rechargeable batteries. During setup, the solar panel assembly is removed from the container and mounted on outside surface of the container or legs in an optimal position.

Located inside the container is an electricity control assembly for the wind generator system that produces electricity which is delivered to outlets on the container, to nearby buildings, to the utility grid, or to the rechargeable battery pack in the container. The electric control assembly includes a D.C. control panel, a D.C. disconnection switch, an inverter, an A.C. disconnection switch, a breaker box, electrical outlets on the container, an electrical meter, and wires that carry A.C. electricity from the container to nearby buildings or the utility electrical grid.

When the unit includes a solar panel assembly, the electricity may be delivered to outlets on the container, to nearby buildings, to the utility grid, or to the rechargeable battery pack in the container. The solar panel assembly includes a controller, a D.C. disconnection switch, an inverter, an A.C. disconnection switch, a main breaker box, outlets, an electrical meter and wires that carry A.C. electricity from the container to nearby buildings or the electrical grid.

### BRIEF DESCRIPTION OF THE DRAWINGS

FIG. 1 is a front perspective view of the portable multiple source electrical power unit showing a storage container with a tower assembly extending vertically above the container with a hub assembly mounted on the tower assembly's distal that is being rotated by wind and showing solar panels attached to sides of the storage container collecting sun light.

FIG. 2 is a left side elevational view of the power unit shown in FIG. 1.

FIG. 3 is a top plan view the power unit shown in FIGS. 1 and 2.

FIG. 4 is a left side elevation view of the power unit showing the tower assembly being lowered for disassembly or maintenance.

FIG. 5 is a left side, front perspective view of the power unit shown the tower assembly disposed on the ground.

FIG. 6 is a right side, front perspective view of the power unit shown the tower assembly disposed on the ground.

FIG. 7 is a front perspective view of the power unit showing the blades and nacelle, and low rpm generator disassembled from the tower assembly and the tower assembly is disassembled into tower sections that are stored inside the container.

FIG. 8 is a front perspective view of the container showing the stored positions of the various components with the legs retracted and diagonally extended.

FIG. 9 is a top plan view of the container shown in FIG. 8.

FIG. 10 is a side elevation view of the container shown in FIGS. 8 and 9.

FIG. 11 is a rear view of the container showing the location of the outside storage box.

FIG. 12 is a front perspective view of the container filed with the multiple source power generating components and ready for transport.

FIG. 13 is a top plan view of the container shown in FIG. 12.

FIG. 14 is a sectional, side elevational view of the container with the support arm extended and showing the lower tower section mounted on a support pedestal and held upright by a hydraulic arm both located inside the container, and showing the water generator located on the floor of the container and various electrical switch boxes and inverters attached to the inside wall of the container.

FIG. 15 is a is a sectional, side elevational view of the container similar to the view shown in FIG. 14 but with the lower tower section being partially lowered.

FIG. 16 is a is a sectional, side elevational view of the container similar to the view shown in FIGS. 14 and 15 but with the lower tower section being fully lowered.

FIG. 17 is a left side elevation view of the container showing the solar panels mounted thereon.

FIG. 18 is a sectional left side elevational of the container showing the pedestal and lower tower section removed.

FIG. 19 is a partial front elevational view of the container with the tower assembly deployed showing three side platforms mounted on the opposite sides and rear sections of the container with concrete blocks stacked on each platforms to provide a counterweight to hold the tower assembly upright in the wind.

FIG. 20 is a top plan view the container with side platforms and concrete blocks shown in FIG. 19.

FIG. 21 is a front perspective view of a second embodiment that uses a small rectangular box container that holds a dissembled wind generator unit.

FIG. 22 is a front perspective view of the second embodiment shown in FIG. 1 with one side wall folded downward to form a lower leg platform.

FIG. 23 is a front perspective view of the second embodiment shown in FIG. 1 with two side walls folded downward, one side wall being folded downward and one side wall in a closed position.

FIG. 24 is a front perspective view of the second embodiment shown in FIG. 1 with four side walls being folded downward to form four laterally extending leg platforms from a center base.

FIG. 25 is a front perspective view of the second embodiment shown in FIG. 1 showing some of the wind generator unit components removed from the container positioned for assembly.

FIG. 26 is a front perspective view of the second embodiment shown in FIG. 1 showing the assembly of the tower.

FIG. 27 is a front perspective view of the second embodiment shown in FIG. 1 showing the tower fully assembled and positioned horizontally and showing the nacelle attached to the distal end of the tower.

FIG. 28 is a front perspective view of the second embodiment shown in FIG. 1 showing the hub assembly, the blades, the nacelle attached to the tower and showing the tower being rotated to a vertical position over the lower support base.

FIG. 29 is a front perspective view of the second embodiment shown in FIG. 1 showing the wind generator unit in a vertical configuration and showing a set of cement blocks positioned over the legs that act as ballasts or counterweights.

FIG. 30 is a front elevational view of the second embodiment shown in FIG. 29.

FIG. 31 is a front perspective view of the lightweight hub assembly that includes five airfoil-shaped sail blades with their tear away skins shown in a fully extended positions

FIG. 32 is a rear perspective view similar of the hub assembly shown in FIG. 31.

FIG. 33 is a front elevational view of the hub assembly shown in FIGS. 31 and 32.

FIG. 34 is a front perspective view of the nacelle that is disposed between the top tower section and the wind generator.

FIG. 35 is a front perspective view of the nacelle with the outer cover removed thereby showing the drive and locking mechanism used to selectively rotate and lock the hub assembly in a desired direction on the end of the tower assembly.

FIG. 36 is a sectional, side elevational view of the nacelle shown in FIG. 34.

FIG. 37 is a front perspective view of an optional water generator that may be used to generate power and purify water.

FIG. 38 is a side elevational view of the water generator.

FIG. 39 is an end elevational view of the water generator and purification unit.

FIG. 40 is a perspective view of the water generator and purification unit.

FIG. 41 is top plan view of the unit.

FIG. 42 is an exploded view of the unit.

### DETAILED DESCRIPTION OF THE PREFERRED EMBODIMENT(S)

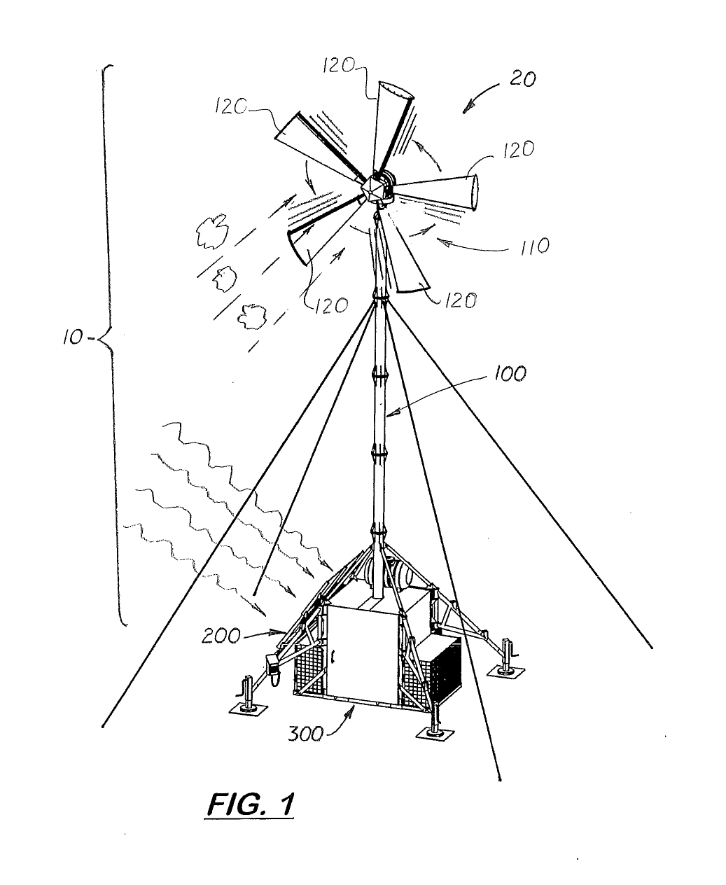

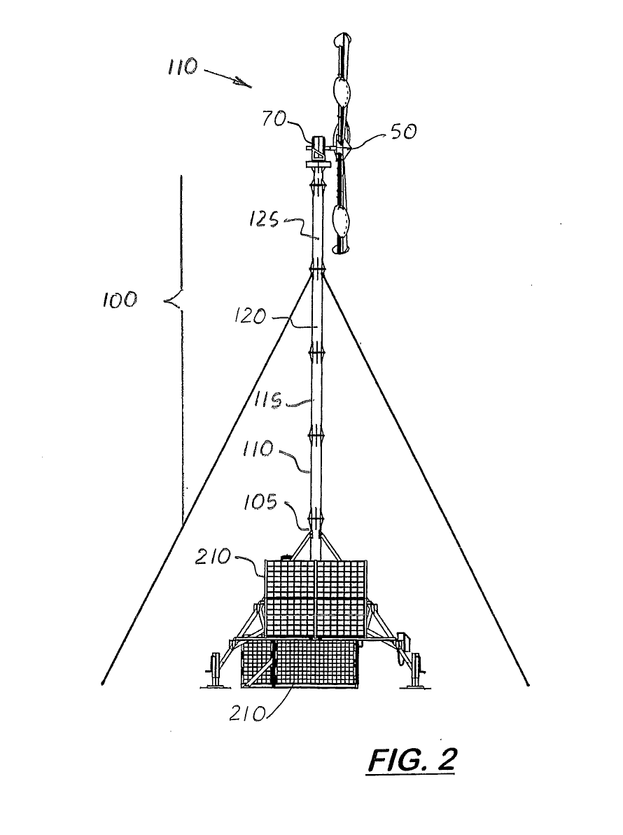

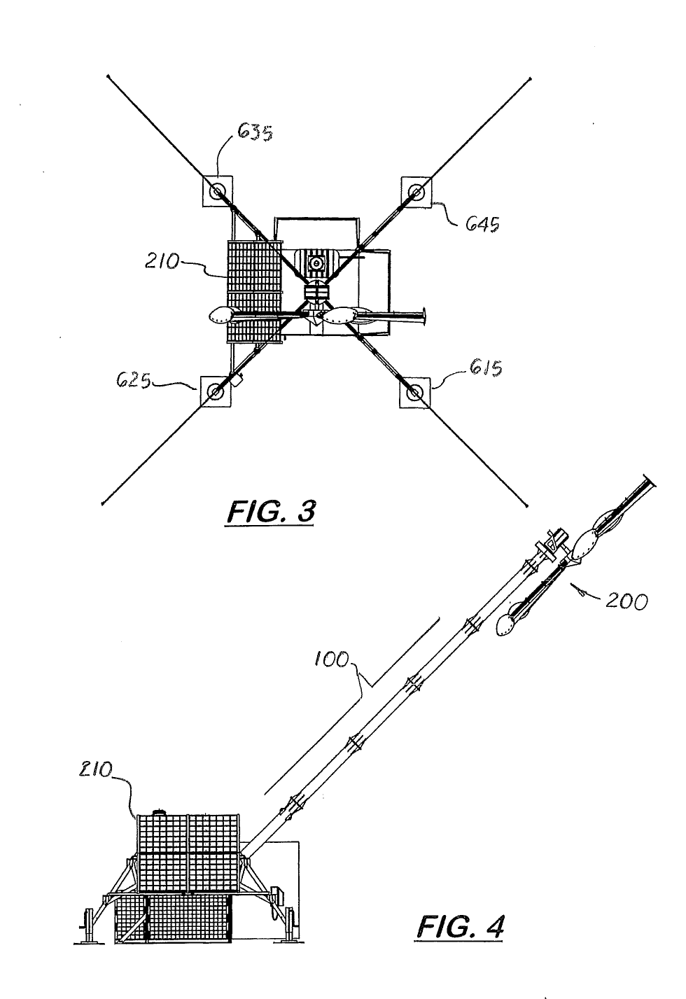

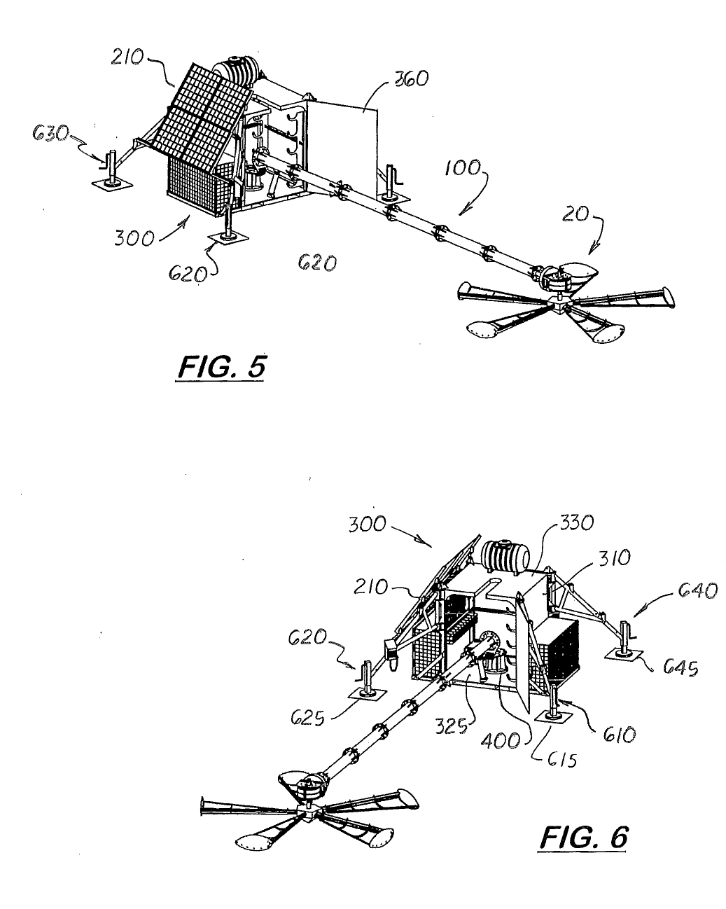

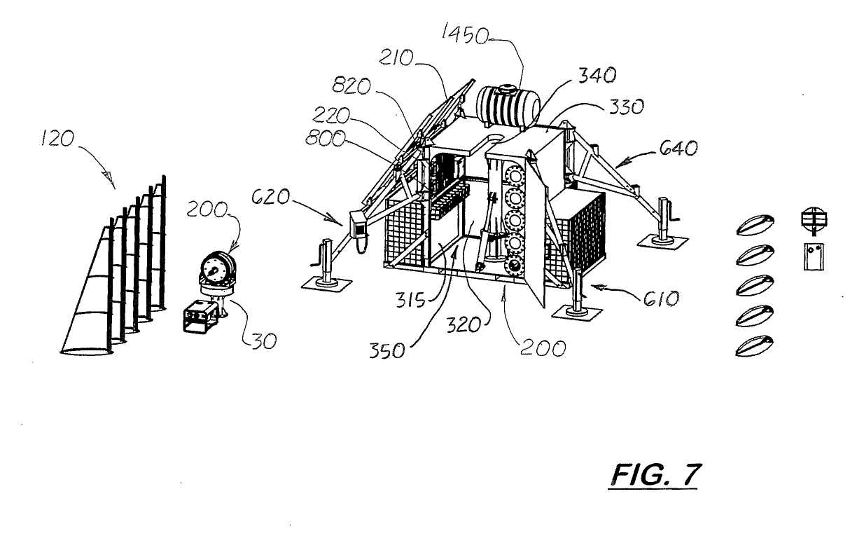

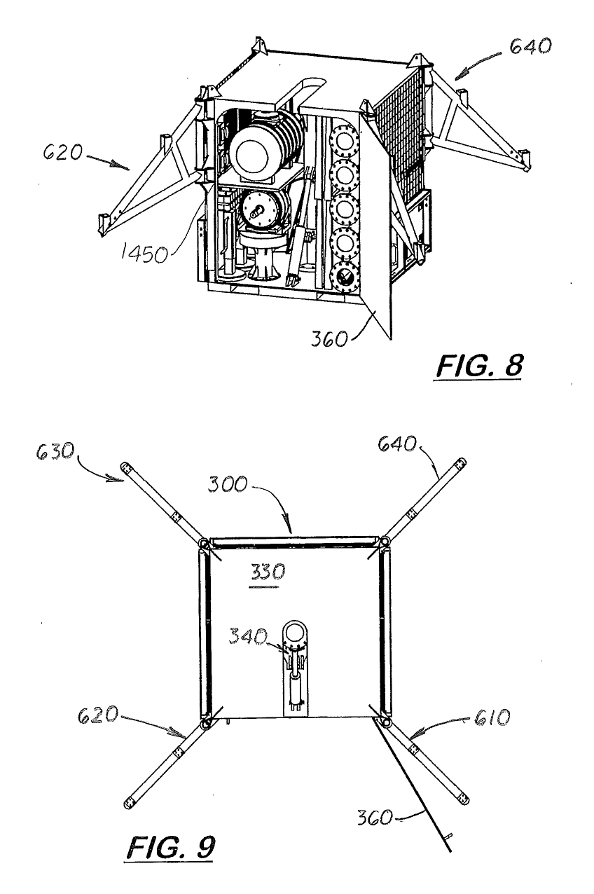

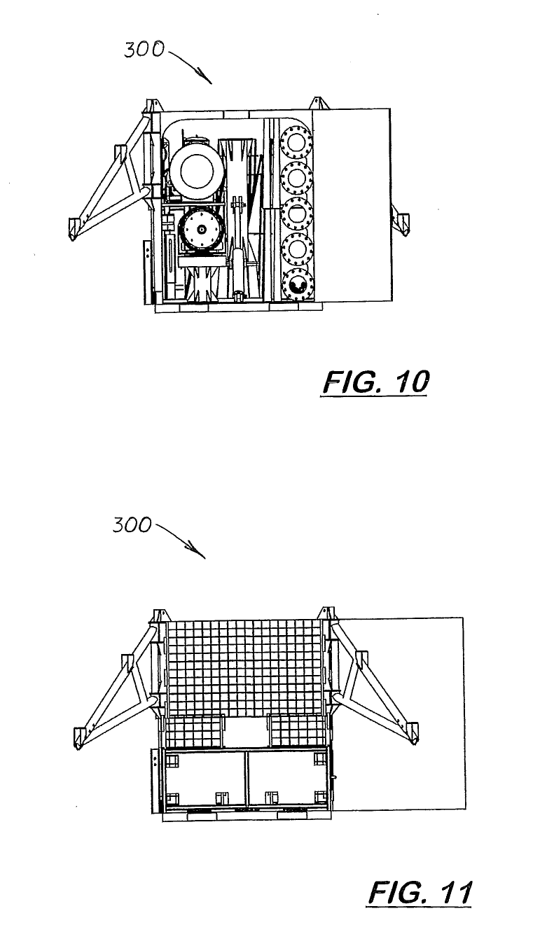

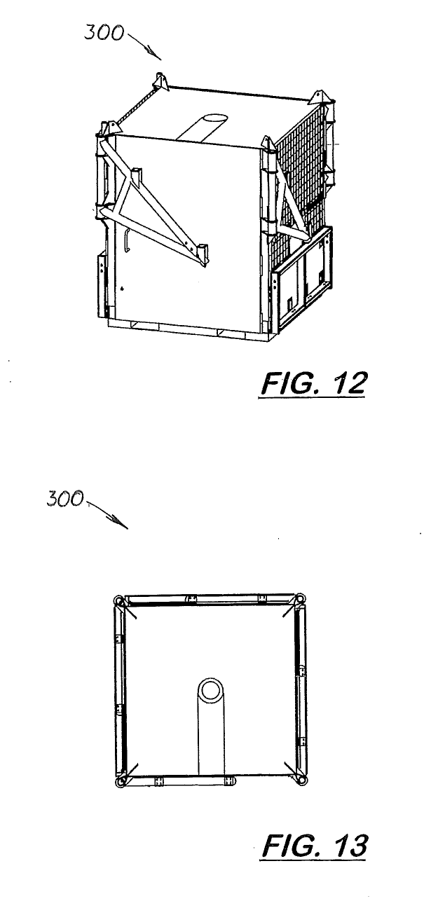

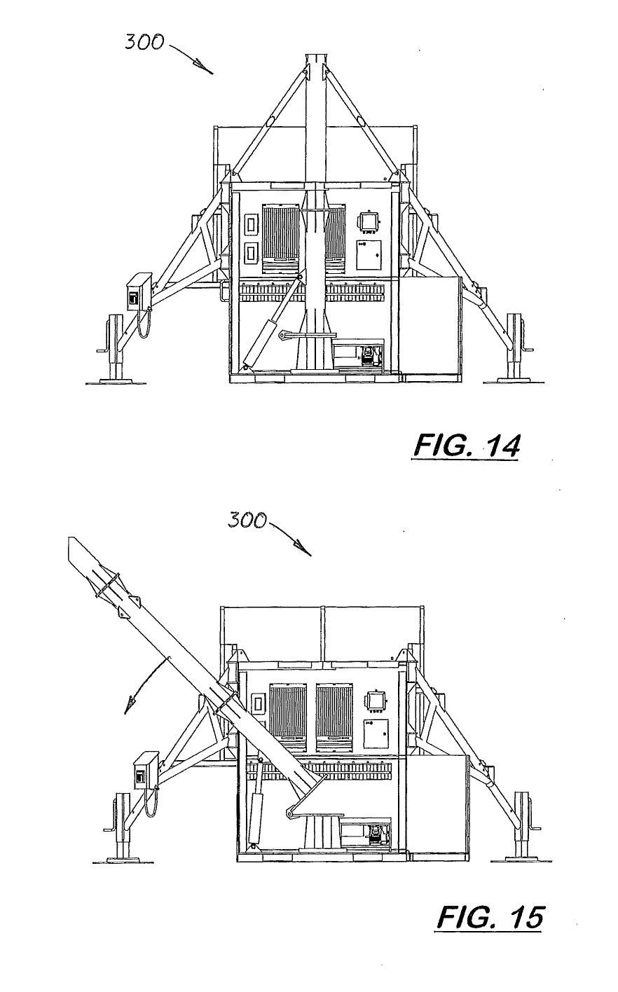

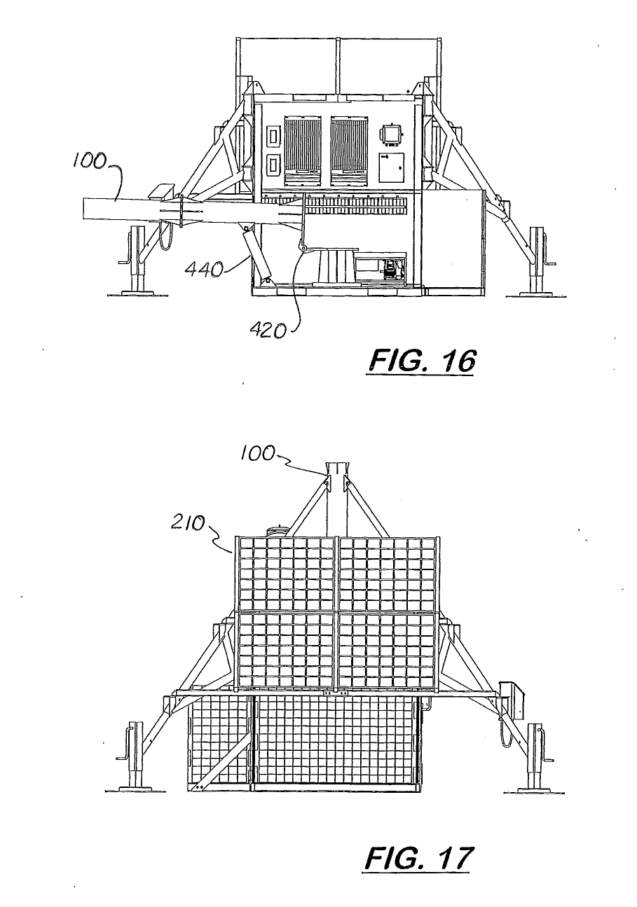

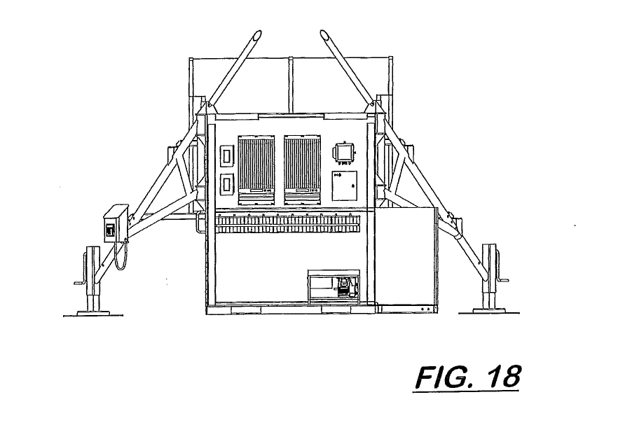

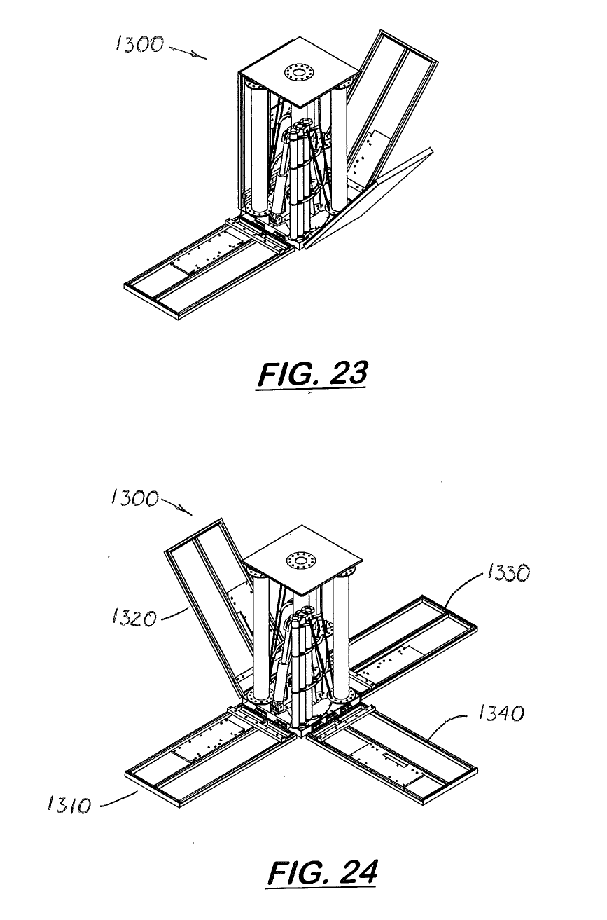

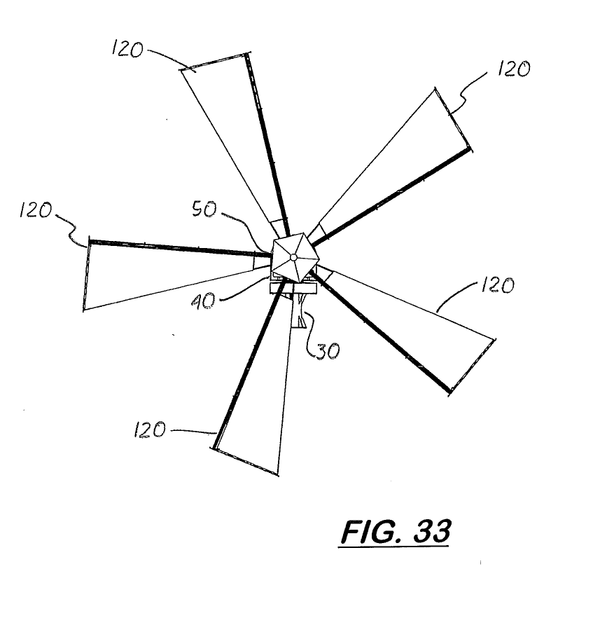

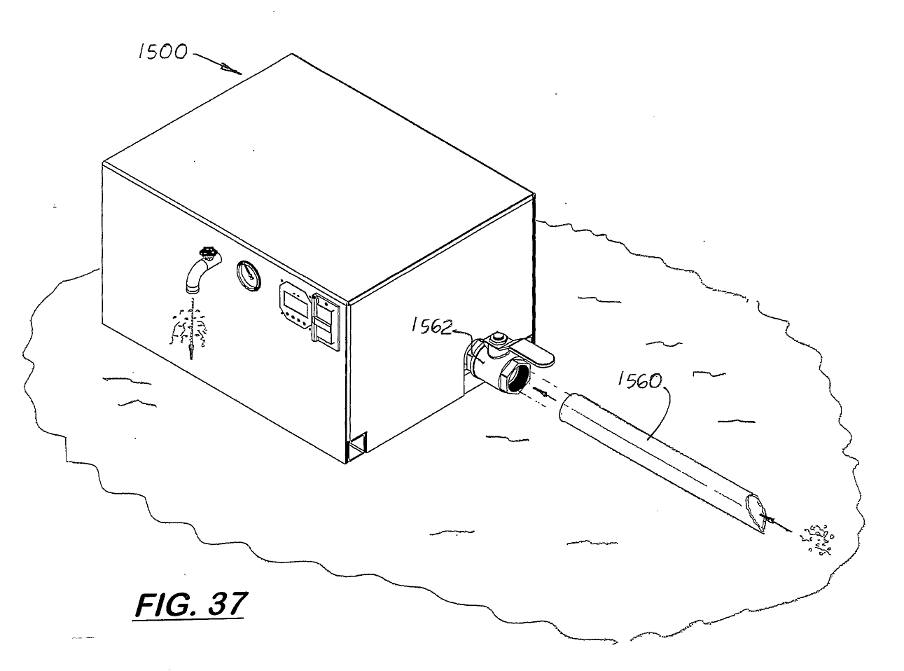

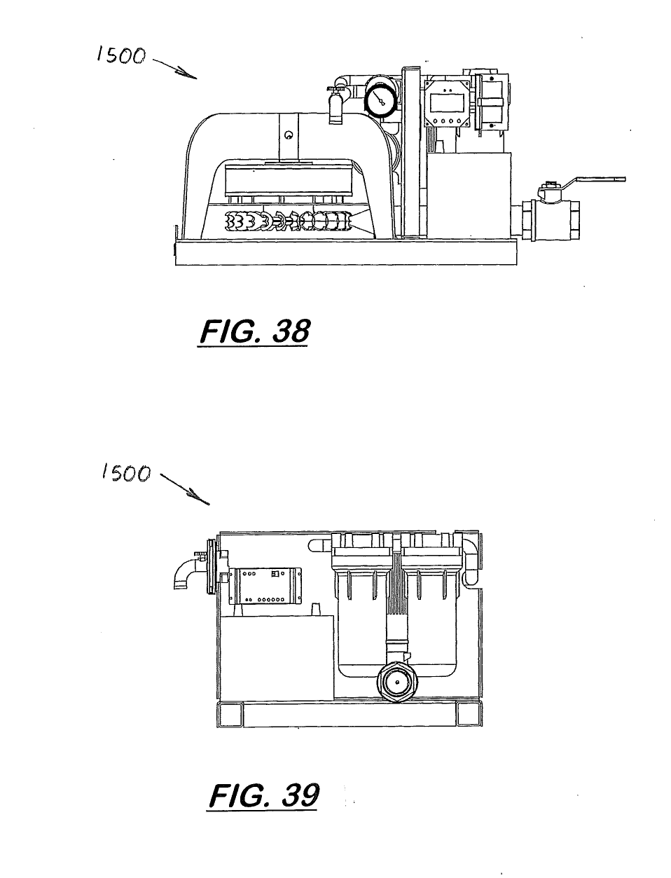

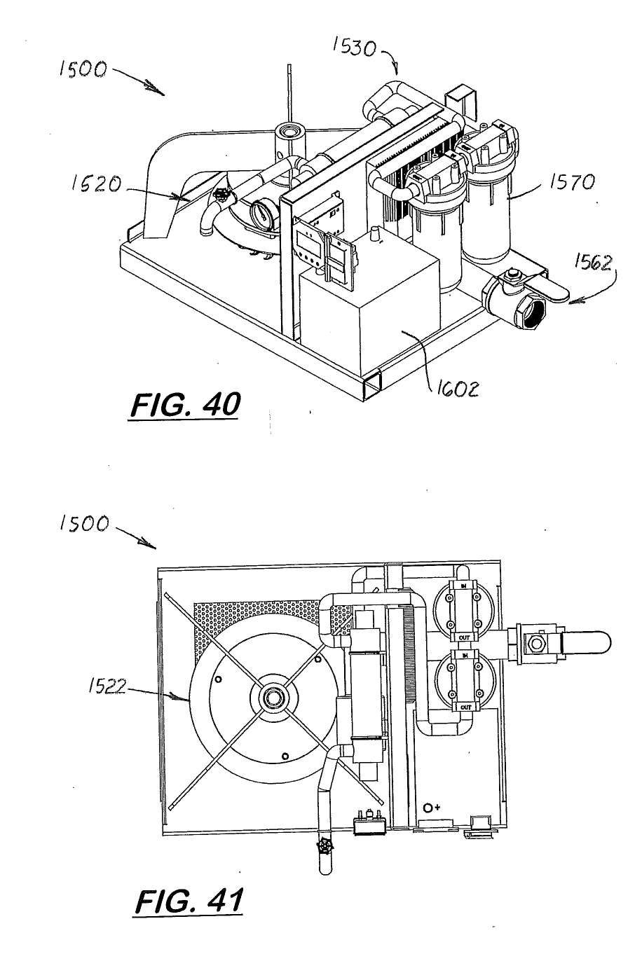

Referring to the accompanying FIGS. 1-42, there is shown a portable, non-fossil fuel, multiple source, electrical power unit 10 that includes a lightweight wind generator assembly 20 and an optional solar panel assembly 200 partially disassembled and stored in a rigid, protecting container 300. The unit 10 includes a tower assembly 100 made up of a plurality of tower members 105, 110, 115, 120, and 125 that are removed and assembled in an end to end manner to form an elongated tower assembly 100. Attached to the distal end of the top tower section is a rotating nacelle 30. Attached to the nacelle 30 is a wind generator assembly 20 that includes a high torque, low RPM wind generator 200 attached to a rotating hub assembly 50 that uses lightweight sail/airfoil shaped blades 120.

In the first embodiment, the lower end of the lower tower member 105 is attached to a pedestal 400 mounted on the floor panel 325 of the container 300. Attached to the floor panel 325 is a base 326. Disposed between the base 326 and the lower tower member 106 is a hinge mechanism 420. During operation, the hinge mechanism 420 and the hydraulic arm 440 are used to rotate the tower assembly 400 from a horizontal to a vertical position over the container 300.

The container 300 includes two side walls 310, 315, a rear wall 320, a floor panel 325 and a top panel 330. Formed in the top panel 330 is a slot 340 that allows the tower assembly 100 to slide through the top panel 330 when aligned in a vertical position. The container 300 also includes a large front opening 350 covered by a rotating door 360.

Pivotally attached to the four corners of the container 300 are four length adjustable legs 610, 620, 630, and 640. Attached to the end of each leg 610, 620, 630 and 640 is a length adjustable foot, 615, 625, 635, and 645, respectively.

Attached to at least one side of the container 300 are one or more optional solar panels 210. The solar panels 210 are diagonally aligned and supported by frame work 220 mounted on the outside surface of the container 300. Created on the sides of the container 300 are optional storage boxes 700.

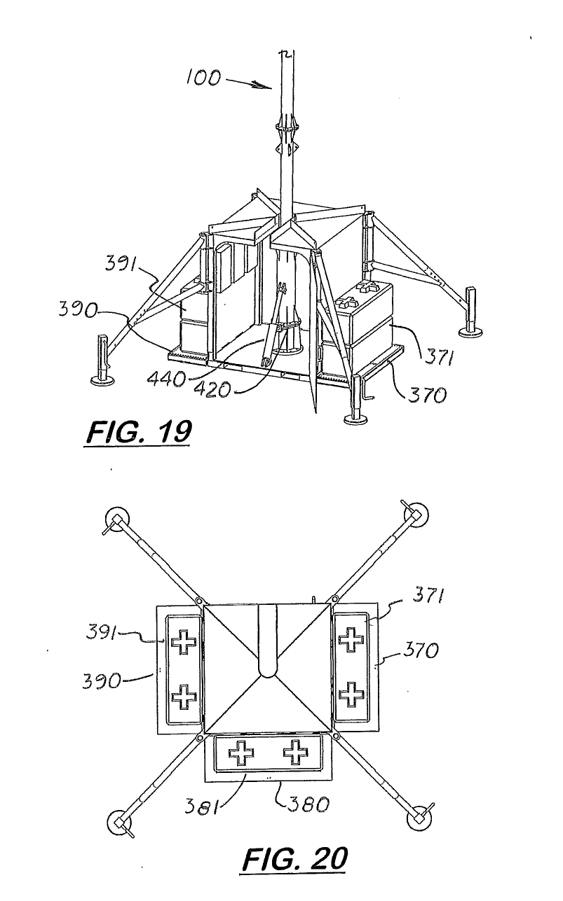

As shown in FIGS. 19 and 20, in one embodiment the container 300 may include three side platforms 370, 380, 390 mounted on the opposite sides and rear sections of the container 300 with concrete blocks 371, 381, 391 stacked on each platforms 370, 380, and 390 to provide a counterweight to hold the tower assembly 100 upright in the wind.

Located inside the container 300 is a bank of rechargeable batteries 800 and an electronic control assembly 820 that enables the operator to control the electrical output from the wind generator assembly 20 and the solar panels 210. The tower members 105, 110, 115, 120, and 125 are stacked along one side of the container 300

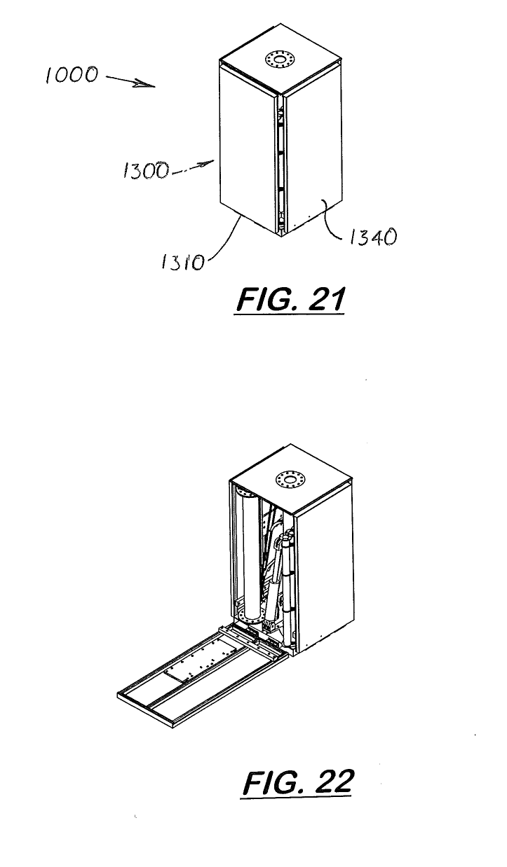

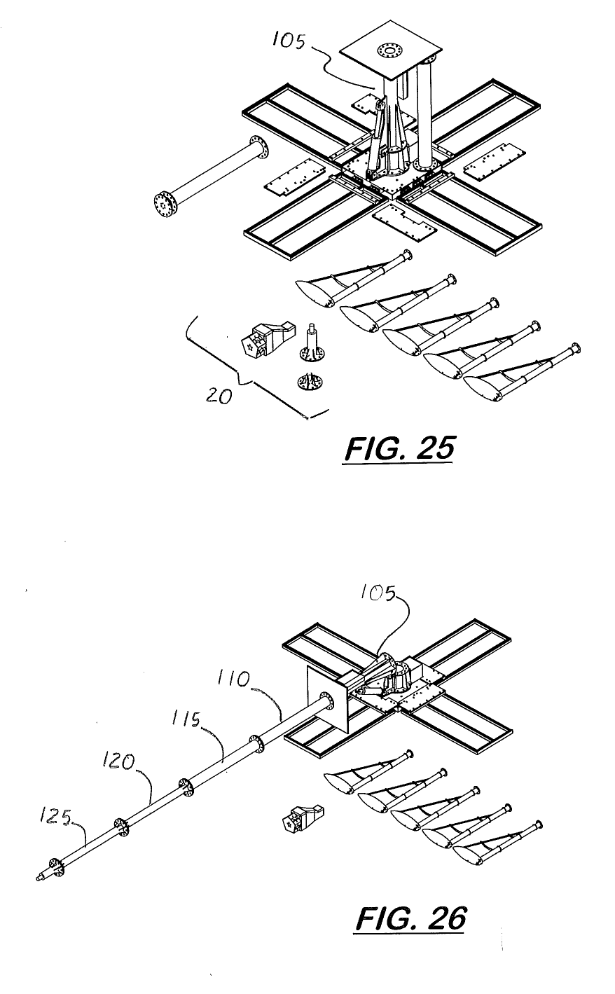

FIGS. 21-30 show a second embodiment of the portable electrical power assembly 1000 that uses a small rectangular box container 1300 with four side walls 1310, 1320, 1330 and 1340 that unfold to create a wide support base. During assembly, the container 1300 is placed on a flat surface and the four side walls 1310, 1320, 1330 and 1340 are sequentially unfolded as shown in FIGS. 22-24. As shown in FIG. 25, the wind generator assembly 20, the modified tower assembly, the nacelle 30, the hub assembly 40, and blades 120 are removed from the container 1300. The lower tower support 105, is mounted on a pivoting hub base 1400 connected to a hydraulic cylinder 1450. The hub base 1400 is tilted horizontally to allow the towers sections 105, 110, 115, 120, and 125 to be easily attached in an end-to-end manner on the ground Each tower section 105, 110, 115, 120, and 125 measures 6 to 10 ft in length thereby creating a tower 30 to 50 feet in height. (see FIG. 26).

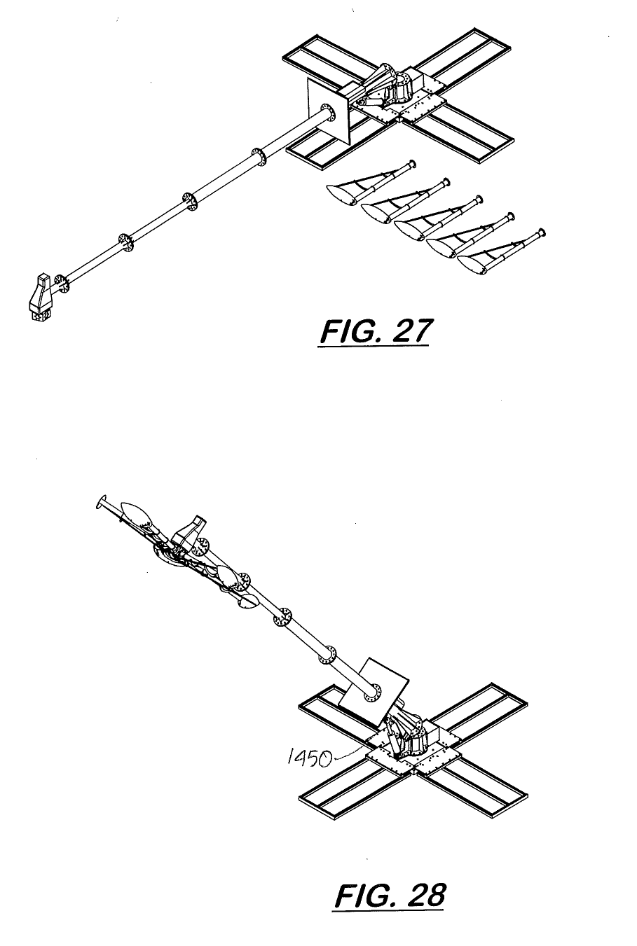

After the upper tower section 125 has been attached, the nacelle 30 is attached to the upper tower member 125. The hub assembly 50 and rotor assembly 70 are then attached to the nacelle 30 (see FIG. 27). The hydraulic cylinder is then activated to rotate the tower assembly, the nacelle 30, the hub assembly 50, and blades 120 to a vertical position (see FIG. 28).

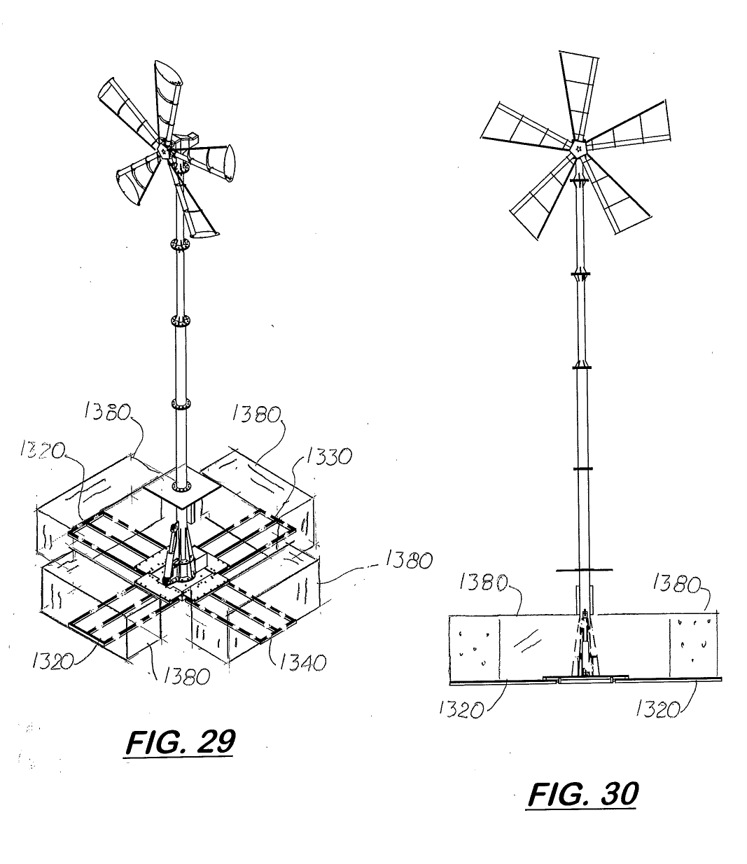

FIGS. 29 and 30 show a set of four cement blocks 1380 positioned over the side panels 1320-1340 that act as ballasts or counterweights.

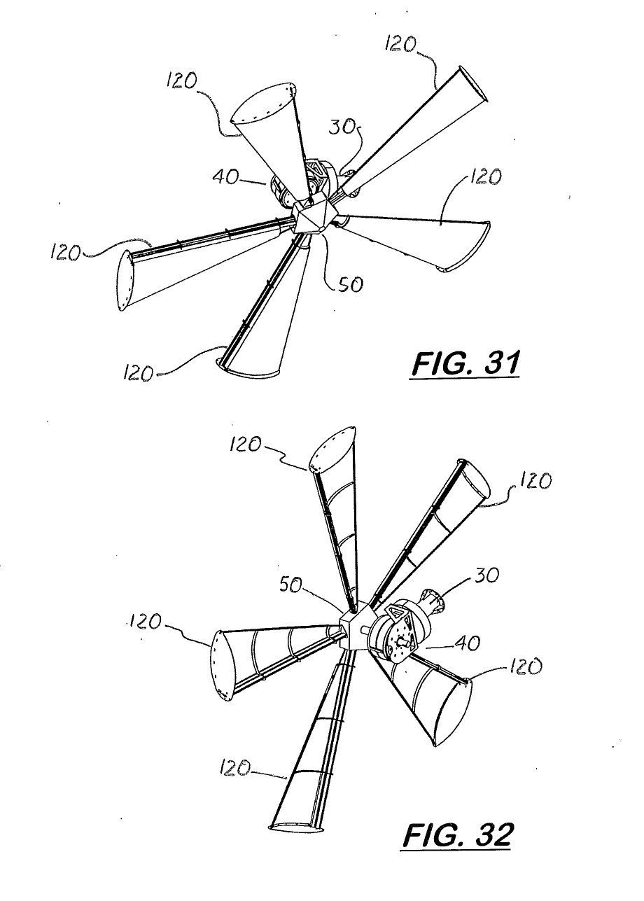

In each embodiment, the wind generator assembly 20 uses a low torque wind generator 200 and a plurality of light weight hybrid blades 120 that function as an airfoil and as a sail. The wind generator 200 and the hybrid blades 120 are shown and described in U.S. utility patent application (application Ser. No. 13/824,243) filed on Mar. 15, 2013 and now incorporated herein. As shown in FIGS. 31-33, the blades 120 are attached to a center hub assembly 50 that connects to an efficient, relatively lightweight, high torque, axially aligned direct drive generator 200. The generator 200 is mounted on top of a nacelle 30 is attached to the tower assembly 100. As stated above, the tower assembly 100 is hydraulic lifted from a horizontal position to a vertical position when winds are sufficiently strong. The nacelle 30 includes a drive mechanism 32 that causes the nacelle 30 and hub assembly 50 to rotate over the end of the tower assembly 100 so that the blades 120 attached to the hub assembly 50 are always perpendicularly aligned with the wind. Optional directional and wind speed sensors are provided that constantly measure the direction and velocity of the wind.

A key aspect of the invention is the use of a highly efficient hybrid airfoil-sale blade 120 that includes a lightweight skin extended over the blade's lightweight frame work which is disclosed in U.S. utility patent application (application Ser. No. 13/824,243) filed on Mar. 15, 2013 and now incorporated herein. The skin is extended over the long side of a blade 120 that has an oval, airfoil cross-sectional shape. A plurality of blades 120 are evenly spaced apart and extend radially outward from the center hub that is connected to the wind generator 200. The skin is aligned longitudinally over each blade 120 and over the long curved surface. Each blade 120 is rotated on the hub assembly 50 so that the skin faces rearward in the opposite direction of the wind. A small portion of the wind travels over the blade's leading edge. A large portion of the wind is forced against the inside surface of the skin and then travels over the edges of the skin. The dual movement of the wind over the blade 120, creates a highly efficient blade system the captures a higher percentage of wind energy. Edges of the skins are attached to the blade's frame work with hook and work connectors. Although as stated above, the system includes sensors and motors that continuously adjust and move the nacelle 30, the hub assembly 50 and the blades 120 in a direction perpendicular to the wind, each skin will automatically detach along one or more edges and flap in the wind if the sensors or motor fail.

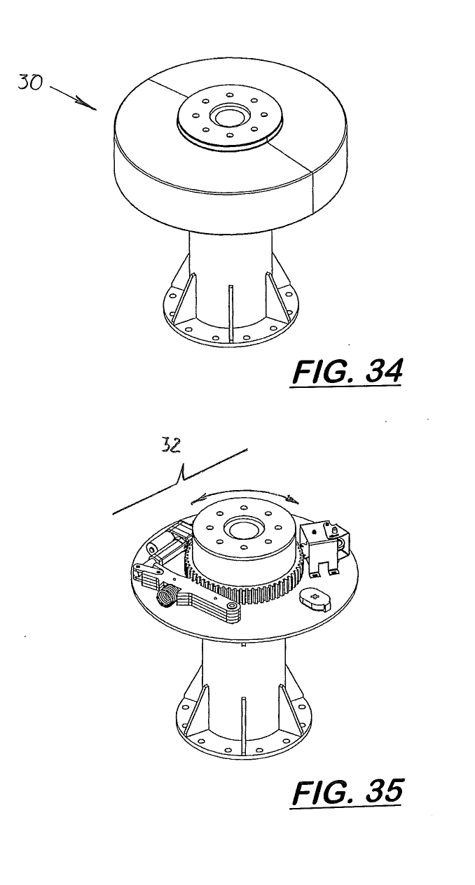

The generator 200 is attached to a nacelle 30, shown in FIGS. 34-36, that attaches to distal end of the upper tower member 100. The nacelle 30 includes a drive and locking mechanism 32 used to selectively rotate and lock the generator and hub assembly 50 in a desired direction on the end of the tower assembly. The nacelle 30 and the drive and locking mechanism 32 are shown and described in the international patent application PCT/US/144606 filed on Jun. 9, 2014 and now incorporated herein.

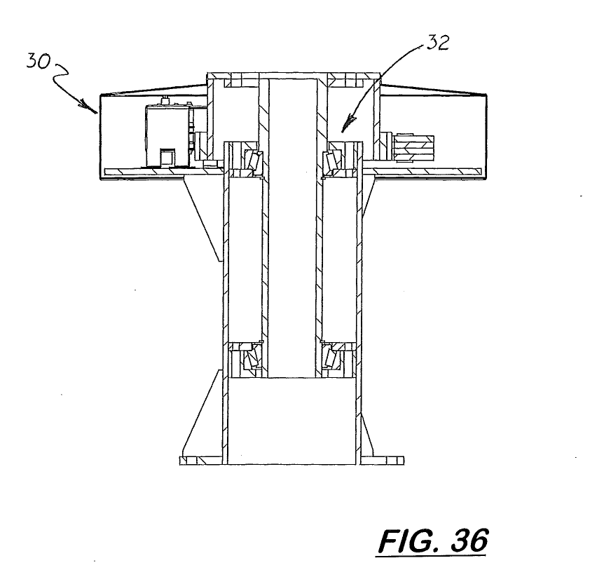

The above described power unit 10 may also include a hydro electric generator and water purification unit 1500 used to generate electricity and purify water from a nearby water source or stored in a storage tank 1450 located on the top of the container 300 or 1300. As shown in FIGS. 36-42, the unit 1500 includes a low volume hydro generator 1520 that fluidly communicates with an elevated water source so that a continuous flow of water with minimal head pressure is delivered to the hydro generator 1520. Electricity produced by the hydro generator 1520 may be stored in a build-in battery 1602. The water purification assembly 1500 is coupled to a second battery 1540 designed to purifies all or a portion of the water used to rotated the hydro electric generator 1520. The battery may be connected to a G.F.C.I. receptacle that allows the energy stored on the battery to be used to energize other electrical devices.

In the embodiment shown herein, the purification unit 1500 includes a flexible hose 1560 that connects at one end to ball valve 1562. The opposite end of the hose 1560 is extended into a water source (not shown) so that water flows via gravity through the hose 1560 to the purification unit 1500. A pre-filter 1570 is connected to the end of the hose 1560 to prevent large debris from entering the purification unit 1500.

The hydro electric generator 1520 is also a high torque, axial aligned generator connected to a fixed axle 1523. An example of a high torque, axial aligned generator is shown in U.S utility patent application (application Ser. No. 13/180,381) filed Jul. 11, 2011 which is now incorporated herein. Located inside the fixed axle 1523 is a drive shaft (not shown) with a water wheel 1528 attached at one end. The opposite end of the drive shaft connects to a static disc located inside the generator's cylindrical housing. Water delivered from the hose 1560 flows through a nozzle 1580 that creates a high velocity jet stream of water and directs it at the vanes on the water wheel 1528 causing the water wheel 1528 and the drive shaft to rotated and produce electricity.

The water purification unit 1500 filters and disinfects some of the water after rotating the hydro electric generator 1520. After contacting the water wheel 1528 a portion of the water is collected in a reservoir 1590. An electric pump 1600 is connected to the battery 1602 and transmits the water in the reservoir 1590 to a sediment filter, a carbon filter and an electric UV disinfectant unit 1530 also connected to the battery 1602

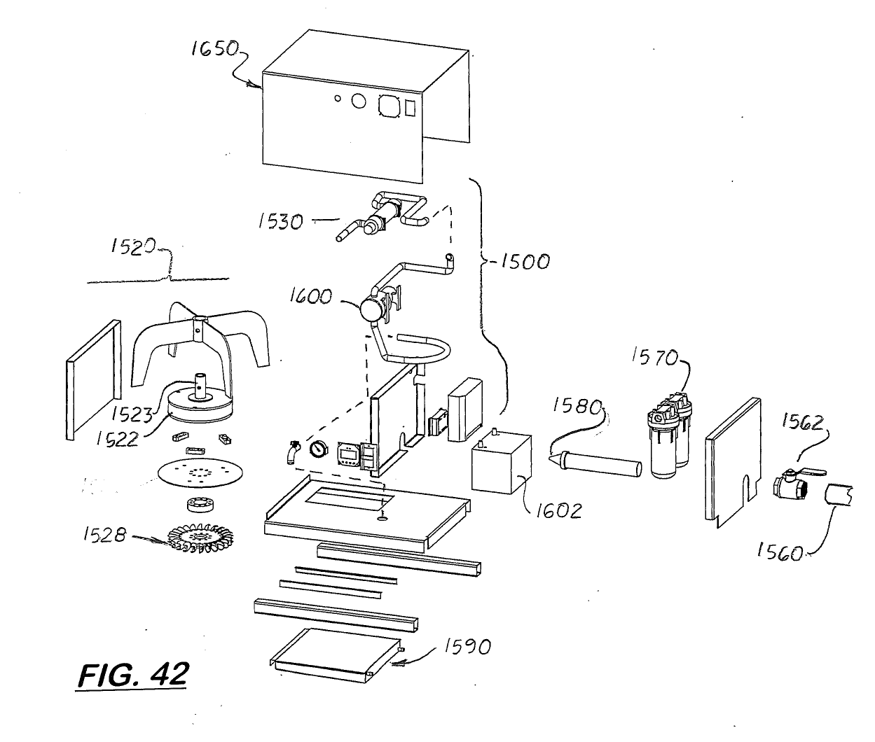

As shown in FIG. 42, both the hydro electric generator 1520 and water purification unit 150 are disposed within a compact housing 1650 and may be stored in the container 300 or 1300.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A portable, electrical power unit, comprising:
a. rigid container;
b. a disassembled, lightweight wind generator assembly located inside said container, said wind generator assembly includes a plurality of tower members that when removed and assembled in an end to end manner, form an elongated tower, said wind generator also includes a hub and a rotor assembly that uses lightweight sail/airfoil shaped blades is attached to the upper end of said tower, said lower end of said tower being pivotally attached to said container enabling said tower to be rotated from a horizontal position to a vertical position over said container;
c. at least lateral legs pivotally attached to said container;
d. a bank of rechargeable batteries; and
e. an electric control assembly disposed between said wind generator that selectively controls the electrical output from the wind generator and said solar panel assembly.

2. The portable electrical power unit as recited in claim 1, further including a solar panel assembly partially disassembled and stored in said container, said solar panel when removed from said container are selectively mounted to said container;

3. The portable electrical power unit as recited in claim 1, wherein said container includes four side walls, a floor panel, and a roof panel, said side walls being pivotally attached to said floor panel thereby enabling said side walls to be folded upward and perpendicular to said floor panel or unfolded into horizontal alignment with said floor panel

4. The portable electrical power unit as recited in claim 1, further including a lower tower member attached to a pivoting base connected to at least one hydraulic cylinder.
